(19) United States
(12) Patent Application Publication
(10) Pub. No.: US 2025/0361254 A1
(43) Pub. Date: Nov. 27, 2025

(54) HIGH PURITY BIS (ARENE) METAL COMPLEXES

(71) Applicant: ENTEGRIS, INC., Billerica, MA (US)

(72) Inventor: David Kuiper, Brookfield, CT (US)

(21) Appl. No.: 19/215,290

(22) Filed: May 21, 2025

Related U.S. Application Data
(60) Provisional application No. 63/650,292, filed on May 21, 2024.

(51) Int. Cl. C07F 11/00

(52) U.S. Cl. CPC C07F 11/00

(57) ABSTRACT

High purity bis (arene) metal complexes and related methods and related compositions are provided. Compositions are provided comprising a bis (arene) metal complex having a purity of at least 95%. Methods for purifying bis (arene) metal complexes are provided. Methods for producing bis (arene) metal complexes at high conversion are also provided.

### CROSS-REFERENCE TO RELATED APPLICATIONS

This application claims the benefit under 35 USC 119 of U.S. Provisional Patent Application No. 63/650,292, filed May 21, 2024, the disclosure of which is hereby incorporated herein by reference in its entirety.

### FIELD

The present disclosure relates to high purity bis (arene) metal complexes and related methods and related compositions, among other things.

### BACKGROUND

Metal arene complexes are a class of organometallic compounds useful for a variety of applications. Some applications in which metal arene complexes are useful require highly pure forms of metal arene complexes. However, conventional purification is difficult, expensive, time-consuming, and inefficient.

### SUMMARY

Some embodiments relate to a method. In some embodiments, the method comprises obtaining a first solution comprising a bis (arene) metal complex and at least one first impurity. In some embodiments, the method comprises heating at least the first solution, in a presence of an arene compound, to obtain a second solution comprising the bis (arene) metal complex and at least one second impurity. In some embodiments, the method comprises contacting the second solution with at least a halide compound to obtain a third solution comprising a bis (arene) metal cation complex and at least one third impurity. In some embodiments, the method comprises separating at least the bis (arene) metal cation complex from at least a portion of the at least one third impurity. In some embodiments, the method comprises contacting the bis (arene) metal cation complex with at least an aqueous reductant and an organic solvent to obtain the bis (arene) metal complex in the organic solvent. In some embodiments, the method comprises separating the bis (arene) metal complex from the organic solvent to obtain a purified bis (arene) metal complex.

Some embodiments relate to a method. In some embodiments, the method comprises obtaining a first solution comprising a bis (arene) metal complex and at least one first impurity. In some embodiments, the method comprises contacting the first solution with a halide compound to obtain a second solution comprising a bis (arene) metal cation complex and at least one second impurity. In some embodiments, the method comprises separating the bis (arene) metal cation complex from at least a portion of the at least one second impurity. In some embodiments, the method comprises contacting the bis (arene) metal cation complex with an aqueous reductant and an organic solvent to obtain the bis (arene) metal complex in the organic solvent. In some embodiments, the method comprises separating the bis (arene) metal complex from the organic solvent to obtain a purified bis (arene) metal complex.

Some embodiments relate to a method. In some embodiments, the method comprises obtaining a first solution. In some embodiments, the first solution comprises reaction products formed by reacting a first metal halide compound, with a second metal halide compound and a first arene compound to form a bis (arene) metal complex and at least one first impurity. In some embodiments, the at least one first impurity comprises a bis (arene) metal complex impurity. In some embodiments, the method comprises heating the first solution, in a presence of a second arene compound, sufficient to convert a portion of the at least one first impurity to the bis (arene) metal complex.

Some embodiments relate to a composition. In some embodiments, the composition comprises a bis (arene) metal complex of the formula:

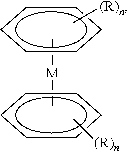

where:

M is a Cr, Mo, W, Fe, or V;

R is independently an alkyl; and

n is 1 to 6. In some embodiments, the bis (arene) metal complex is present

in the composition at a purity of at least 95%.

### BRIEF DESCRIPTION OF FIGURES

FIG. 1 is a flowchart of a method of purifying a bis (arene) metal complex, according to some embodiments.

FIG. 2 is a schematic diagram of a reaction scheme for purification via an oxidation-reduction sequence, according to some embodiments.

FIG. 3 is a schematic diagram of a reaction scheme for thermal arene metathesis reactions, according to some embodiments.

FIG. 4 is a schematic diagram of a reaction scheme for a combination of thermal arene metathesis and oxidation-reduction sequence, according to some embodiments.

FIG. 5 is a schematic diagram of a reaction scheme for increased conversion of crude product, according to some embodiments.

FIG. 6 is a graphical view of the thermogravimetric analysis (TGA) for the impure cured bis (toluene) molybdenum, according to some embodiments.

FIG. 7 is a graphical view of the thermogravimetric analysis (TGA) for the purified bis (toluene) molybdenum, according to some embodiments.

FIG. 8 is a graphical view of ¹H NMR spectrum showing the conversion over time for ethylbenzene arene metathesis reactions, according to some embodiments.

FIG. 9 is a graphical view of ¹H NMR spectrum showing the conversion over time for ethylbenzene arene metathesis reactions, according to some embodiments.

### DETAILED DESCRIPTION

As used herein, the term “alkyl” refers to a hydrocarbyl having from 1 to 30 carbon atoms. The alkyl may be attached via a single bond. An alkyl having n carbon atoms may be designated as a “Cₙ alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₃₀ alkyl, C₁-C₂₉ alkyl, C₁-C₂₈ alkyl, C₁-C₂₇ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof. In some embodiments, the term “alkyl” refers generally to alkyls, alkenyls, alkynyls, and/or cycloalkyls.

As used herein, the term “alkenyl” refers to a hydrocarbyl having from 1 to 30 carbon atoms and at least one carbon-carbon double bond. In some embodiments, the alkenyl comprises or is selected from the group consisting of at least one of a C₁-C₃₀ alkenyl, C₁-C₂₉ alkenyl, C₁-C₂₈ alkenyl, C₁-C₂₇ alkenyl, C₁-C₂₇ alkenyl, C₁-C₂₆ alkenyl, C₁-C₂₅ alkenyl, C₁-C₂₄ alkenyl, C₁-C₂₃ alkenyl, C₁-C₂₂ alkenyl, C₁-C₂₁ alkenyl, C₁-C₂₀ alkenyl, C₁-C₁₉ alkenyl, C₁-C₁₈ alkenyl, C₁-C₁₇ alkenyl, C₁-C₁₆ alkenyl, C₁-C₁₅ alkenyl, C₁-C₁₄ alkenyl, C₁-C₁₃ alkenyl, C₁-C₁₂ alkenyl, C₁-C₁₁ alkenyl, C₁-C₁₀ alkenyl, a C₁-C₉ alkenyl, a C₁-C₈ alkenyl, a C₁-C₇ alkenyl, a C₁-C₆ alkenyl, a C₁-C₅ alkenyl, a C₁-C₄ alkenyl, a C₁-C₃ alkenyl, a C₁-C₂ alkenyl, a C₂-C₃₀ alkenyl, a C₃-C₃₀ alkenyl, a C₄-C₃₀ alkenyl, a C₅-C₃₀ alkenyl, a C₆-C₃₀ alkenyl, a C₇-C₃₀ alkenyl, a C₈-C₃₀ alkenyl, a C₉-C₃₀ alkenyl, a C₁₀-C₃₀ alkenyl, a C₁₁-C₃₀ alkenyl, a C₁₂-C₃₀ alkenyl, a C₁₃-C₃₀ alkenyl, a C₁₄-C₃₀ alkenyl, a C₁₅-C₃₀ alkenyl, a C₁₆-C₃₀ alkenyl, a C₁₇-C₃₀ alkenyl, a C₁₈-C₃₀ alkenyl, a C₁₉-C₃₀ alkenyl, a C₂₀-C₃₀ alkenyl, a C₂₁-C₃₀ alkenyl, a C₂₂-C₃₀ alkenyl, a C₂₃-C₃₀ alkenyl, a C₂₄-C₃₀ alkenyl, a C₂₅-C₃₀ alkenyl, a C₂₆-C₃₀ alkenyl, a C₂₇-C₃₀ alkenyl, a C₂₈-C₃₀ alkenyl, a C₂₉-C₃₀ alkenyl, a C₂-C₁₀ alkenyl, a C₃-C₅ alkenyl, a C₄-C₁₀ alkenyl, a C₅-C₁₀ alkenyl, a C₆-C₁₀ alkenyl, a C₇-C₁₀ alkenyl, a C₈-C₁₀ alkenyl, a C₂-C₉ alkenyl, a C₂-C₈ alkenyl, a C₂-C₇ alkenyl, a C₂-C₆ alkenyl, a C₂-C₅ alkenyl, a C₃-C₅ alkenyl, or any combination thereof. Examples of alkenyl groups include, without limitation, at least one of vinyl, allyl, 1-methylvinyl, 1-propenyl, 1-butenyl, 2-butenyl, 3-butenyl, 1,3-butadienyl, 2-methyl-1-propenyl, 2-methyl-2-propenyl, 1-pentenyl, 2-pentenyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 3-heptenyl, 1-octenyl, 1,3-octadienyl, 1-nonenyl, 2-nonenyl, 3-nonenyl, 1-decenyl, 3-decenyl, 1-undecenyl, oleyl, linoleyl, linolenyl, or any combination thereof.

As used herein, the term “cycloalkyl” refers to a non-aromatic carbocyclic ring having from 3 to 8 carbon atoms in the ring. The term includes a monocyclic non-aromatic carbocyclic ring and a polycyclic non-aromatic carbocyclic ring. The term “monocyclic,” when used as a modifier, refers to a cycloalkyl having a single cyclic ring structure. The term “polycyclic,” when used as a modifier, refers to a cycloalkyl having more than one cyclic ring structure, which may be fused, bridged, spiro, or otherwise bonded ring structures. For example, two or more cycloalkyls may be fused, bridged, or fused and bridged to obtain the polycyclic non-aromatic carbocyclic ring. In some embodiments, the cycloalkyl may comprise, consist of, or consist essentially of, or may be selected from the group consisting of, at least one of cyclopropyl, cyclobutyl, cyclopentyl, cyclohexyl, cycloheptyl, cyclooctyl, or any combination thereof.

As used herein, the term “aryl” refers to a monocyclic or polycyclic aromatic hydrocarbon. The number of carbon atoms of the aryl may be in a range of 5 carbon atoms to 100 carbon atoms. In some embodiments, the aryl has 5 to 20 carbon atoms. For example, in some embodiments, the aryl has 6 to 8 carbon atoms, 6 to 10 carbon atoms, 6 to 12 carbon atoms, 6 to 15 carbon atoms, or 6 to 20 carbon atoms. The term “monocyclic,” when used as a modifier, refers to an aryl having a single aromatic ring structure. The term “polycyclic,” when used as a modifier, refers to an aryl having more than one aromatic ring structure, which may be fused, bridged, spiro, or otherwise bonded ring structures. In some embodiments, the aryl is —C₆H₅.

Non-limiting examples of aryls include, without limitation, at least one of benzene, toluene, xylene (e.g., o-xylene, m-xylene, p-xylene), t-butyltoluene (e.g., o-t-butyltoluene, m-t-butyltoluene, p-t-butyltoluene), ethylmethylbenzene (e.g., 1-ethyl-4-methylbenzene, 1-ethyl-3-methylbenzene), 1-isopropyl-4-methylbenzene, 1-t-butyl-4-methylbenzene, mesitylene, pseudocumene, durene, methylbenzene, dimethylbenzene, trimethylbenzene, ethylbenzene, diethylbenzene (e.g., 1,4-diethylbenzene), triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof, and the like.

As used herein, the term “amino” and/or “amine” refers to a functional group of formula —N(R^{a}R^{b}), wherein R^{a} and R^{b} are independently a hydrogen, an alkyl (as defined herein), an aminoalkyl (as defined herein), or a silyl (as defined herein), or R^{a} and R^{b} are bonded to each other to form a C₃-C₂₀ N-heterocycle. In some embodiments, the amino may comprise an alkylamino or a dialkylamino. In some embodiments, the amino may comprise at least one of methylamino, dimethylamino, ethylamino, diethylamino, isopropylamino, di-isopropylamino, butylamino, sec-butylamino, tert-butylamino, di-sec-butylamino, isobutylamino, di-isobutylamino, di-tert-pentylamino, ethylmethylamino, isopropyl-n-propylamino, or any combination thereof. Examples of the alkylamines may include, without limitation, one or more of the following: primary alkylamines, such as, for example and without limitation, methylamine, ethylamine, n-propylamine, isopropylamine, n-butylamine, sec-butylamine, isobutylamine, t-butylamine, pentylamine, 2-aminopentane, 3-aminopentane, 1-amino-2-methylbutane, 2-amino-2-methylbutane, 3-amino-2-methylbutane, 4-amino-2-methylbutane, hexylamine, 5-amino-2-methylpentane, heptylamine, octylamine, nonylamine, decylamine, undecylamine, dodecylamine, tridecylamine, tetradecylamine, pentadecylamine, hexadecylamine, heptadecylamine, and octadecylamine; secondary alkylamines, such as, for example and without limitation, dimethylamine, diethylamine, dipropylamine, diisopropylamine, dibutylamine, diisobutylamine, di-sec-butylamine, di-t-butylamine, dipentylamine, dihexylamine, diheptylamine, dioctylamine, dinonylamine, didecylamine, methylethylamine, methylpropylamine, methylisopropylamine, methylbutylamine, methylisobutylamine, methyl-sec-butylamine, methyl-t-butylamine, methylamylamine, methylisoamylamine, ethylpropylamine, ethylisopropylamine, ethylbutylamine, ethylisobutylamine, ethyl-sec-butylamine, ethylamine, ethylisoamylamine, propylbutylamine, and propylisobutylamine; and tertiary alkylamines, such as, for example and without limitation, trimethylamine, triethylamine, tripropylamine, tributylamine, tripentylamine, dimethylethylamine, methyldiethylamine, and methyldipropylamine. Examples of polyamines may include, without limitation, one or more of the following: ethylenediamine, propylenediamine, trimethylenediamine, tetramethylenediamine, 1,3-diaminobutane, 2,3-diaminobutane, pentamethylenediamine, 2,4-diaminopentane, hexamethylenediamine, heptamethylenediamine, octamethylenediamine, nonamethylenediamine, N-methylethylenediamine, N,N-dimethylethylenediamine, trimethylethylenediamine, N-ethylethylenediamine, N,N-diethylethylenediamine, triethylethylenediamine, 1,2,3-triaminopropane, hydrazine, tris (2-aminoethyl) amine, tetra (aminomethyl) methane, diethylenetriamine, triethylenetetramine, tetraethylpentamine, heptaethyleneoctamine, nonaethylenedecamine, and diazabicyloundecene. Unless otherwise provided herein, the terms “amine” and “amino” may be used interchangeably throughout this disclosure.

As used herein, the term “aralkyl” refers to an alkyl as defined herein, wherein at least one of the hydrogen atoms of the alkyl is replaced with an aryl as defined herein. In some embodiments, the term “aralkyl” refers to a functional group of formula -(alkyl) (aryl), wherein the alkyl is defined herein and the aryl is defined herein. In some embodiments, the aralkyl is —CH₂ (C₆H₅).

As used herein, the term “aminoalkyl” refers to an alkyl as defined herein, wherein at least one of the hydrogen atoms of the alkyl is replaced with an amino as defined herein. In some embodiments, the term “aminoalkyl” refers to a functional group of formula -(alkyl)N(R^{b}R^{c}R^{d}), wherein the alkyl is defined above and wherein R^{b}, R^{c}, and Rd are defined above. In some embodiments, the aminoalkyl is —CH₂N(CH₃)₂. In some embodiments, the aminoalkyl is —(CH₂)₃N(CH₃)₂. In some embodiments, the aminoalkyl is aminomethyl (—CH₂NH₂). In some embodiments, the aminoalkyl is N,N-dimethylaminoethyl (—CH₂CH₂N(CH₃)₂). In some embodiments, the aminoalkyl is 3-(N-cyclopropylamino)propyl (—CH₂CH₂CH₂NH—Pr).

As used herein, the term “halide” refers to a —Cl, —Br, —I, or —F.

As used herein, the term “metal” refers to at least one of an alkali metal, an alkaline earth metal, a transition metal, a post-transition metal, or any combination thereof. In some embodiments, the metal comprises a metal cation. In some embodiments, the metal cation comprises at least one of a lithium cation, a sodium cation, a potassium cation, a rubidium cation, a cesium cation, a francium cation, a beryllium cation, a magnesium cation, a calcium cation, a strontium cation, a barium cation, a radium cation, a scandium cation, a titanium cation, a vanadium cation, a chromium cation, a manganese cation, an iron cation, a cobalt cation, a nickel cation, a copper cation, a zinc cation, a yttrium cation, a zirconium cation, a niobium cation, a molybdenum cation, a technetium cation, a ruthenium cation, a rhodium cation, a palladium cation, a silver cation, a cadmium cation, a hafnium cation, a tantalum cation, a tungsten cation, a rhenium cation, an osmium cation, an iridium cation, a platinum cation, a gold cation, a mercury cation, an aluminum cation, a gallium cation, an indium cation, tin cation, a thallum cation, a lead cation, a bismuth cation, a polonium cation, or any combination thereof. The charge(s) of the metal cations are known and, for simplicity, thus are not repeated here; however, it will be appreciated that the metal cations can have any known charge.

As used herein, the term “bis (arene) metal complex” refers to any organometallic compound comprising at least two arenes bound (e.g., coordinated) to a metal. Each of the arenes may independently be substituted or unsubstituted. In some embodiments, a bis (arene) metal complex comprises only one substituted arene coordinated to a metal. For example, in some embodiments, the bis (arene) metal complex comprises benzene ethylbenzene molybdenum, where ethylbenzene is the substituted arene. In some embodiments, a bis (arene) metal complex comprises two substituted arenes coordinated to a metal. For example, in some embodiments, the bis (arene) metal complex comprises bis (diethylbenzene) molybdenum, where both diethylbenzenes are substituted arenes. In some embodiments, a bis (arene) metal complex comprises two arenes coordinated to a metal, wherein the two arenes are the same and wherein the two arenes may be substituted or unsubstituted.

Non-limiting examples of bis (arene) metal complexes include, without limitation, at least one of bis (benzene) molybdenum, bis (benzene) tungsten, bis (toluene) molybdenum, bis (toluene) tungsten, bis (xylene) molybdenum, bis (xylene) tungsten, bis (ethylbenzene) molybdenum, bis (ethylbenzene) tungsten, bis (benzene) chromium, bis (ethylbenzene) chromium, bis (toluene) chromium, bis (mesitylene) chromium, bis (mesitylene) molybdenum, bis (tetralin) chromium, bis (diphenyl) chromium, bis (diphenyl) molybdenum, bis (mesitylene) molybdenum, bis (mesitylene) tungsten, bis (benzene) iron, bis (toluene) iron, bis (xylene) chromium, bis (xylene) iron, bis-(mesitylene) iron, bis (durene) iron, bis (hexamethylbenzene) iron, bis (hexamethylbenzene) chromium, bis (benzene) vanadium, bis (toluene) vanadium, any bis (arene isomer) metal complex thereof, or any combination thereof.

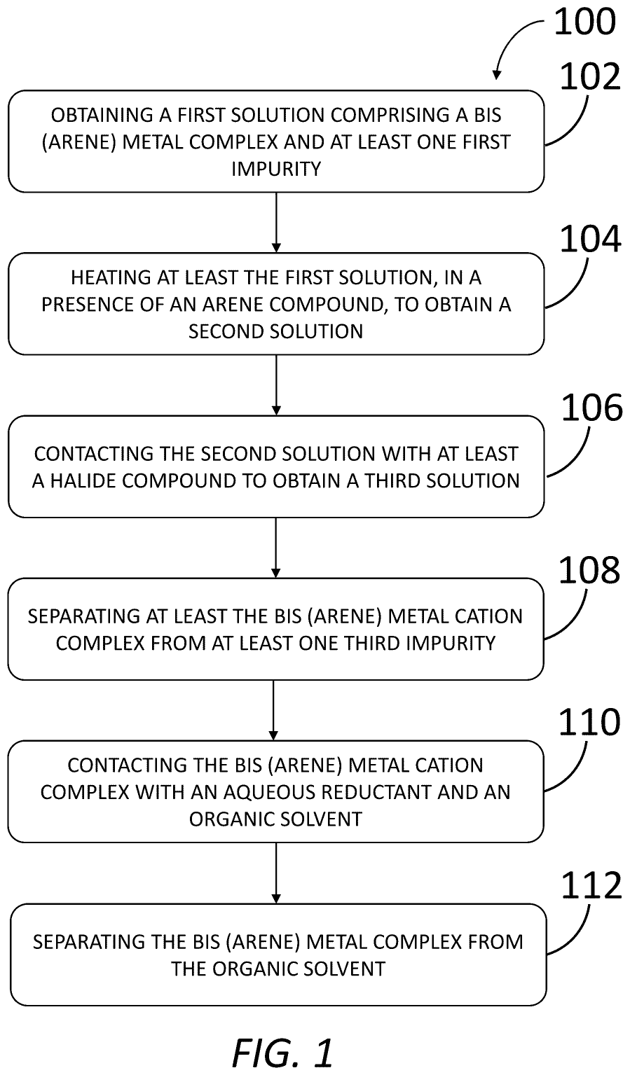

FIG. 1 is a flowchart of a method of purifying a bis (arene) metal complex, according to some embodiments. In some embodiments, the method 100 may comprise one or more of the following steps: a step 102 of obtaining a first solution comprising a bis (arene) metal complex and at least one first impurity; a step 104 of heating at least the first solution, in a presence of an arene compound, to obtain a second solution comprising the bis (arene) metal complex and at least one second impurity; a step 106 of contacting the second solution with at least a halide compound to obtain a third solution comprising a bis (arene) metal cation complex and at least one third impurity; a step 108 of separating at least the bis (arene) metal cation complex from at least a portion of the at least one third impurity; and a step 110 of contacting the bis (arene) metal cation complex with at least an aqueous reductant and an organic solvent to obtain the bis (arene) metal complex in the organic solvent; and a step 112 of separating the bis (arene) metal complex from the organic solvent to obtain a purified bis (arene) metal complex.

At step 102, in some embodiments, the method 100 comprises obtaining a first solution comprising a bis (arene) metal complex and at least one first impurity.

In some embodiments, the bis (arene) metal complex comprises a compound of the formula:

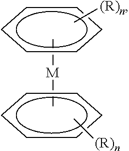

where:

M is a Cr, Mo, W, Fe, or V;

R is independently an alkyl; and

n is 1 to 6.

In some embodiments, the bis (arene) metal complex comprises at least one of a bis (benzene) metal complex, a bis (toluene) metal complex, a bis (xylene) metal complex, a bis (butyltoluene) metal complex, a bis (ethyl methyl benzene) metal complex, a bis (ethyl methylbenzene) metal complex, a bis (isopropyl methyl benzene) metal complex, a bis (butyl methylbenzene) metal complex, a bis (mesitylene) metal complex, a bis (pseudocumene) metal complex, a bis (durene) metal complex, a bis (methylbenzene) metal complex, a bis (dimethylbenzene) metal complex, a bis (trimethylbenzene) metal complex, a bis (ethylbenzene) metal complex, a bis (1,4-diethylbenzene) metal complex, a bis (triethylbenzene) metal complex, a bis (propylbenzene) metal complex, a bis (butylbenzene) metal complex, a bis (iso-butylbenzene) metal complex, a bis (sec-butylbenzene) metal complex, a bis (t-butylbenzene) metal complex, a bis (hexylbenzene) metal complex, a bis (styrene) metal complex, a bis (naphthalene) metal complex, a bis (anthracene) metal complex, a bis (phenanthrene) metal complex, a bis (biphenyl) metal complex, a bis (terphenyl) metal complex, a bis (methylnaphthalene) metal complex, a bis (biphenylene) metal complex, a bis (dimethylnaphthalene) metal complex, a bis (methylanthracene) metal complex, a bis (4,4′-dimethylbiphenyl) metal complex, a bis (bibenzyl) metal complex, a bis (diphenylmethane) metal complex, any isomer thereof, or any combination thereof.

In some embodiments, the at least one first impurity comprises at least one compound having a molecular weight greater than a molecular weight of the bis (arene) metal complex. In some embodiments, the at least one first impurity comprises at least one compound having a molecular weight that is at least 1% greater than a molecular weight of the bis (arene) metal complex. For example, in some embodiments, the at least one first impurity comprises at least one compound having a molecular weight that is at least 5%, 10%, 15%, 20%, 25%, 30%, 35%, 40%, 45%, 50%, 55%, 60%, 65%, 70%, 75%, 80%, 85%, 90%, 95%, or 99% greater than a molecular weight of the bis (arene) metal complex.

In some embodiments, the at least one first impurity comprises at least one of a first bis (arene) metal complex impurity, a first arene impurity, or any combination thereof. In some embodiments the at least one first impurity comprises a first bis (arene) metal complex impurity. In some embodiments the at least one first impurity comprises a first arene impurity.

In some embodiments, the at least one first impurity comprises at least one of the following compounds:

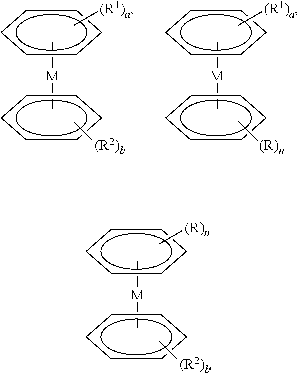

where:

M is a Cr, Mo, W, Fe, or V;

R is independently an alkyl, an alkenyl, an aryl, or a cycloalkyl;

R¹ is independently a halogen, a dialkylamino, an alkyl, an alkoxy, an aryl,

aralkyl, or a cycloalkyl;

R² is independently a halogen, a dialkylamino, an alkyl, an alkoxy, an aryl, aralkyl, or a cycloalkyl;

n is 1 to 6;

a is 1 to 6; and

b is 1 to 6.

In some embodiments, the at least one impurity is detectable by nuclear magnetic resonance (NMR) spectroscopic analysis. In some embodiments, the at least one impurity is detectable by gas chromatography-mass spectrometry (GC-MS) analysis.

In some embodiments, the method comprises, prior to obtaining the first solution, forming the bis (arene) metal complex.

In some embodiments, the first solution comprises 1% to 99% by weight of the bis (arene) metal complex based on a total weight of the first solution, or any range or subrange between 1% and 99%. For example, in some embodiments, the first solution comprises 5% to 99%, 10% to 99%, 15% to 99%, 20% to 99%, 25% to 99%, 30% to 99%, 35% to 99%, 40% to 99%, 45% to 99%, 50% to 99%, 55% to 99%, 60% to 99%, 65% to 99%, 70% to 99%, 75% to 99%, 80% to 99%, 85% to 99%, 90% to 99%, or 95% to 99% by weight of the bis (arene) metal complex based on a total weight of the first solution. In some embodiments, the first solution comprises 1% to 95%, 1% to 90%, 1% to 85%, 1% to 80%, 1% to 75%, 1% to 70%, 1% to 65%, 1% to 60%, 1% to 55%, 1% to 50%, 1% to 45%, 1% to 40%, 1% to 35%, 1% to 30%, 1% to 25%, 1% to 20%, 1% to 15%, 1% to 10%, or 1% to 5% by weight of the bis (arene) metal complex based on a total weight of the first solution.

In some embodiments, the first solution comprises 1% to 99% by weight of the at least one first impurity based on the total weight of the first solution, or any range or subrange between 1% and 99%. For example, in some embodiments, the first solution comprises 5% to 99%, 10% to 99%, 15% to 99%, 20% to 99%, 25% to 99%, 30% to 99%, 35% to 99%, 40% to 99%, 45% to 99%, 50% to 99%, 55% to 99%, 60% to 99%, 65% to 99%, 70% to 99%, 75% to 99%, 80% to 99%, 85% to 99%, 90% to 99%, or 95% to 99% by weight of the at least one first impurity based on the total weight of the first solution. In some embodiments, the first solution comprises 1% to 95%, 1% to 90%, 1% to 85%, 1% to 80%, 1% to 75%, 1% to 70%, 1% to 65%, 1% to 60%, 1% to 55%, 1% to 50%, 1% to 45%, 1% to 40%, 1% to 35%, 1% to 30%, 1% to 25%, 1% to 20%, 1% to 15%, 1% to 10%, or 1% to 5% by weight of the at least one first impurity based on the total weight of the first solution.

At step 104, in some embodiments, the method 100 comprises heating at least the first solution, in a presence of an arene compound, to obtain a second solution comprising the bis (arene) metal complex and at least one second impurity.

In some embodiments, the heating is conducted for a duration sufficient to result in a conversion of 90% to 99%, or any range or subrange between 90% and 99%. For example, in some embodiments, the conversion may be 90.5% to 99%, 91% to 99%, 91.5% to 99%, 92% to 99%, 92.5% to 99%, 93% to 99%, 93.5% to 99%, 94% to 99%, 94.5% to 99%, 95% to 99%, 95.5% to 99%, 96% to 99%, 96.5% to 99%, 97% to 99%, 97.5% to 99%, 98% to 99%, or 98.5% to 99%. In some embodiments, the conversion may be 90% to 98.5%, 90% to 98%, 90% to 97.5%, 90% to 97%, 90% to 96.5%, 90% to 96%, 90% to 95.5%, 90% to 95%, 90% to 94.5%, 90% to 94%, 90% to 93.5%, 90% to 93%, 90% to 92.5%, 90% to 92%, 90% to 91.5%, 90% to 91%, or 90% to 90.5%.

In some embodiments, the heating comprises heating to a temperature sufficient for the at least one second impurity to undergo an exchange with the arene compound to obtain the bis (arene) metal complex.

In some embodiments, the heating comprises heating to a temperature of 160° C. or less for a duration sufficient to result in a conversion of 90% or greater. In some embodiments, the temperature is a temperature in a range of 30° C. to 160° C., or any range or subrange between 30° C. and 160° C. For example, in some embodiments, the temperature is a temperature in a range from 40° C. and 160° C., 50° C. and 160° C., 60° C. and 160° C., 70° C. and 160° C., 80° C. and 160° C., 90° C. and 160° C., 100° C. and 160° C., 110° C. and 160° C., 120° C. and 160° C., 130° C. and 160° C., 140° C. and 160° C., or 150° C. and 160° C. In some embodiments, the temperature is a temperature in a range from 30° C. to 150° C., 30° C. to 140° C., 30° C. to 130° C., 30° C. to 120° C., 30° C. to 110° C., 30° C. to 100° C., 30° C. to 90° C., 30° C. to 80° C., 30° C. to 70° C., 30° C. to 60° C., 30° C. to 50° C., or 30° C. to 40° C.

In some embodiments, the heating is conducted for a duration sufficient to result in a conversion of 90% to 99%, or any range or subrange between 90% and 99%. In some embodiments, the heating is conducted for a duration sufficient to result in a conversion of 90% to 99%, 91% to 99%, 92% to 99%, 93% to 99%, 94% to 99%, 95% to 99%, 96% to 99%, 97% to 99%, 98% to 99%, 90% to 98%, 90% to 97%, 90% to 96%, 90% to 95%, 90% to 94%, 90% to 93%, 90% to 92%, or 90% to 91%. In some embodiments, the heating is conducted for a duration sufficient to convert the at least one second impurity to the bis (arene) metal complex.

In some embodiments, the duration sufficient to result in the conversion of 90% to 99% is a duration of 1 min to 48 hours, or any range or subrange between 1 min and 48 hours. In some embodiments, the duration sufficient to result in the conversion of 90% to 99% is a duration of 1 hr to 48 hr, 6 hr to 48 hr, 12 hr to 48 hr, 18 hr to 48 hr, 24hr to 48 hr, 30 hr to 48 hr, 36 hr to 48 hr, 1 min to 36 hr, 1 min to 30 hr, 1 min to 24 hr, 1min to 18 hr, 1 min to 12 hr, 1 min to 6 hr, or 1 min to 1 hr.

In some embodiments, the arene compound comprises an aromatic compound that is free of heteroatom-containing substituents. In some embodiments, the arene compound comprises a compound of the formula:

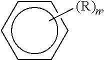

where:

R is independently an alkyl; and

n is 1 to 6.

In some embodiments, an amount of the at least one second impurity in the second solution is less than an amount of the at least one first impurity in the first solution. In some embodiments, an amount of the at least one second impurity in the second solution is at least 1% less than an amount of the at least one first impurity in the first solution. In some embodiments, the at least one second impurity and the at least one first impurity are different. In some embodiments, an amount of the at least one second impurity in the second solution is 1% to 99%, 5% to 99%, 10% to 99%, 15% to 99%, 20% to 99%, 25% to 99%, 30% to 99%, 35% to 99%, 40% to 99%, 45% to 99%, 50% to 99%, 55% to 99%, 60% to 99%, 65% to 99%, 70% to 99%, 75% to 99%, 80% to 99%, 85% to 99%, 90% to 99%, or 95% to 99% less than an amount of the at least one first impurity in the first solution. In some embodiments, an amount of the at least one second impurity in the second solution is 1% to 95%, 1% to 90%, 1% to 85%, 1% to 80%, 1% to 75%, 1% to 70%, 1% to 65%, 1% to 60%, 1% to 55%, 1% to 50%, 1% to 45%, 1% to 40%, 1% to 35%, 1% to 30%, 1% to 25%, 1% to 20%, 1% to 15%, 1% to 10%, or 1% to 5% less than an amount of the at least one first impurity in the first solution.

In some embodiments, the at least one second impurity and the at least one first impurity are different. In some embodiments, the at least one second impurity comprises the at least one first impurity.

In some embodiments, the at least on second impurity comprises at least one of the following:

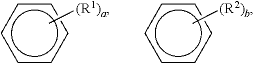

where:

R¹ is independently a halogen, a dialkylamino, an alkyl, an alkoxy, an aryl, aralkyl, or a cycloalkyl;

R² is independently a halogen, a dialkylamino, an alkyl, an alkoxy, an aryl, aralkyl, or a cycloalkyl;

a is 1 to 6; and

b is 1 to 6.

In some embodiments, a purity of the bis (arene) metal complex in the second solution is greater than a purity of the bis (arene) metal complex in the first solution. In some embodiments, a purity of the bis (arene) metal complex in the second solution is at least 1% greater than a purity of the bis (arene) metal complex in the first solution. In some embodiments, a purity of the bis (arene) metal complex in the second solution is 1% to 99%, 5% to 99%, 10% to 99%, 15% to 99%, 20% to 99%, 25% to 99%, 30% to 99%, 35% to 99%, 40% to 99%, 45% to 99%, 50% to 99%, 55% to 99%, 60% to 99%, 65% to 99%, 70% to 99%, 75% to 99%, 80% to 99%, 85% to 99%, 90% to 99%, or 95% to 99% greater than a purity of the bis (arene) metal complex in the first solution. In some embodiments, a purity of the bis (arene) metal complex in the second solution is 1% to 95%, 1% to 90%, 1% to 85%, 1% to 80%, 1% to 75%, 1% to 70%, 1% to 65%, 1% to 60%, 1% to 55%, 1% to 50%, 1% to 45%, 1% to 40%, 1% to 35%, 1% to 30%, 1% to 25%, 1% to 20%, 1% to 15%, 1% to 10%, or 1% to 5% greater than a purity of the bis (arene) metal complex in the first solution.

In some embodiments, the second solution comprises 1% to 99% by weight of the bis (arene) metal complex based on a total weight of the second solution. For example, in some embodiments, the second solution comprises 5% to 99%, 10% to 99%, 15% to 99%, 20% to 99%, 25% to 99%, 30% to 99%, 35% to 99%, 40% to 99%, 45% to 99%, 50% to 99%, 55% to 99%, 60% to 99%, 65% to 99%, 70% to 99%, 75% to 99%, 80% to 99%, 85% to 99%, 90% to 99%, or 95% to 99% by weight of the bis (arene) metal complex based on a total weight of the second solution. In some embodiments, the second solution comprises 1% to 95%, 1% to 90%, 1% to 85%, 1% to 80%, 1% to 75%, 1% to 70%, 1% to 65%, 1% to 60%, 1% to 55%, 1% to 50%, 1% to 45%, 1% to 40%, 1% to 35%, 1% to 30%, 1% to 25%, 1% to 20%, 1% to 15%, 1% to 10%, or 1% to 5% by weight of the bis (arene) metal complex based on a total weight of the second solution.

In some embodiments, the second solution comprises 1% to 99% by weight of the at least one second impurity based on the total weight of the second solution. For example, in some embodiments, the second solution comprises 5% to 99%, 10% to 99%, 15% to 99%, 20% to 99%, 25% to 99%, 30% to 99%, 35% to 99%, 40% to 99%, 45% to 99%, 50% to 99%, 55% to 99%, 60% to 99%, 65% to 99%, 70% to 99%, 75% to 99%, 80% to 99%, 85% to 99%, 90% to 99%, or 95% to 99% by weight of the at least one second impurity based on the total weight of the second solution. In some embodiments, the second solution comprises 1% to 95%, 1% to 90%, 1% to 85%, 1% to 80%, 1% to 75%, 1% to 70%, 1% to 65%, 1% to 60%, 1% to 55%, 1% to 50%, 1% to 45%, 1% to 40%, 1% to 35%, 1% to 30%, 1% to 25%, 1% to 20%, 1% to 15%, 1% to 10%, or 1% to 5% by weight of the at least one second impurity based on the total weight of the second solution.

At step 106, in some embodiments, the method 100 comprises contacting the second solution with at least a halide compound to obtain a third solution comprising a bis (arene) metal cation complex and at least one third impurity.

In some embodiments, the contacting comprises bringing the second solution and at least a halide compound into immediate or close proximity. In some embodiments, the contacting comprises bringing the second solution and at least a halide compound into direct physical contact. In some embodiments, the contacting comprises exposing the second solution to the at least a halide compound. In some embodiments, the contacting comprises introducing, supplying, pumping, drawing (e.g., via vacuum), injecting, flowing, or otherwise providing the second solution such that the second solution and at least a halide compound are contacted. In some embodiments, the contacting comprises stirring the second solution and at least a halide compound. In some embodiments, the contacting comprises mixing the second solution and at least a halide compound. In some embodiments, the contacting comprises agitating the second solution and at least a halide compound. In some embodiments, the contacting comprises adding the second solution and at least a halide compound to a reaction vessel (e.g., a flask, a vial, etc.). In some embodiments, the contacting comprises combining the second solution and at least a halide compound in a reaction vessel. In some embodiments, the second solution and at least a halide compound are contacted sequentially, in any order. In some embodiments, the second solution and at least a halide compound are contacted substantially simultaneously or simultaneously.

In some embodiments, the second solution and the halide compound are contacted at a temperature of 15° C. to 35° C., or any range or subrange between. For example, in some embodiments, the temperature is a temperature in a range from 20° C. to 35° C., 25° C. to 35° C., 30° C. to 35° C., 15° C. to 30° C., 15° C. to 25° C., or 15° C. to 20° C.

In some embodiments, the halide compound comprises a compound of the formula:

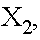

where:

X is Cl, Br, F, or I.

In some embodiments, the halide compound comprises at least one of I₂, Br₂, Cl₂, ICl, IBr, or any combination thereof.

In some embodiments, the bis (arene) metal cation complex comprises a compound of the formula:

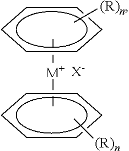

where:

M is a Cr, Mo, W, Fe, or V;

X is CI, Br, I, or F;

R is independently an alkyl; and

n is 1 to 6.

It will be appreciated that the charge on the metal cation, M⁺, will vary depending on the metal. Accordingly, it will also be appreciated that the charge on the metal cation, M⁺, can be +1, +2, +3, +4, +5, or +6; and that the number of halides can vary to correspond with the charge on the metal cation, M⁺.

In some embodiments, the contacting of the second solution with the halide compound is sufficient for the bis (arene) metal cation complex to precipitate. In some embodiments, the bis (arene) metal cation complex is present in the third solution in a solid phase. For example, in some embodiments, the bis (arene) metal cation complex comprises a solid bis (arene) metal cation complex.

In some embodiments, the at least one third impurity is different from the bis (arene) Metal complex. In some embodiments, the at least one third impurity comprises at least one of the at least one first impurity, the at least one second impurity, a hydrocarbon solvent-soluble impurity, an aromatic solvent-soluble impurity, an ethereal solvent-soluble impurity, or any combination thereof. In some embodiments, the at least one third impurity comprises at least one compound of the formula:

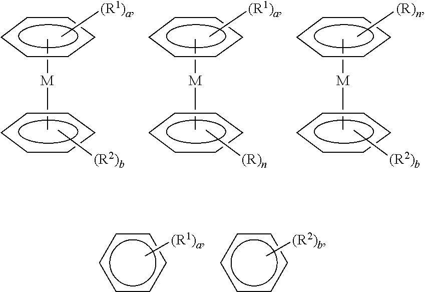

or any combination thereof, where:

M is a Cr, Mo, W, Fe, or V;

R is independently an alkyl, an alkenyl, an aryl, or a cycloalkyl;

R¹ is independently a halogen, a dialkylamino, an alkyl, an alkoxy, an aryl, aralkyl, or a cycloalkyl;

R² is independently a halogen, a dialkylamino, an alkyl, an alkoxy, an aryl, aralkyl, or a cycloalkyl;

n is 1 to 6;

a is 1 to 6;

b is 1 to 6.

In some embodiments, (R¹)ₐ and (R²)_{b} are different from (R)ₙ.

In some embodiments, at least a portion of the at least one third impurity is present in the third solution in a liquid phase. In some embodiments, the amount of the at least one third impurity in the third solution is less than the amount of the at least one second impurity in the second solution. In some embodiments, the at least one third impurity comprises at least one of a hydrocarbon solvent-soluble impurity, an aromatic solvent-soluble impurity, an ethereal solvent-soluble impurity, or any combination thereof.

At step 108, in some embodiments, the method comprises separating at least the bis (arene) metal cation complex from at least a portion of the at least one third impurity.

In some embodiments, the separating comprises filtering the third solution to separate the bis (arene) metal cation complex from the at least one third impurity. In some embodiments, the separating comprises removing the at least one third impurity to separate the bis (arene) metal cation complex. In some embodiments, the separating comprises siphoning the at least one third impurity to separate the bis (arene) metal complex. In some embodiments, the separating comprises screening the third solution to separate the bis (arene) metal cation complex from the at least one third impurity. In some embodiments, the separating comprises pouring the third solution onto a filter media (e.g., filter paper) to separate the bis (arene) metal cation complex from the at least one third impurity.

At step 110, in some embodiments, the method comprises contacting the bis (arene) metal cation complex with at least an aqueous reductant and an organic solvent to obtain the bis (arene) metal complex in the organic solvent.

In some embodiments, the contacting comprises bringing the bis (arene) metal cation complex and at least an aqueous reductant and an organic solvent into immediate or close proximity. In some embodiments, the contacting comprises bringing the bis (arene) metal cation complex and at least an aqueous reductant and an organic solvent into direct physical contact. In some embodiments, the contacting comprises exposing the bis (arene) metal cation complex to the at least a reductant compound and an organic solvent. In some embodiments, the contacting comprises introducing, supplying, pumping, drawing (e.g., via vacuum), injecting, flowing, or otherwise providing the bis (arene) metal cation complex such that the bis (arene) metal cation complex and at least an aqueous reductant and an organic solvent are contacted. In some embodiments, the contacting comprises stirring the bis (arene) metal cation complex and at least a reductant compound and an organic solvent. In some embodiments, the contacting comprises mixing the bis (arene) metal cation complex and at least a reductant compound and an organic solvent. In some embodiments, the contacting comprises agitating the bis (arene) metal cation complex and at least reductant compound and an organic solvent. In some embodiments, the contacting comprises adding the bis (arene) metal cation complex and at least an aqueous reductant and an organic solvent to a reaction vessel (e.g., a flask, a vial, etc.). In some embodiments, the contacting comprises combining the bis (arene) metal cation complex and at least an aqueous reductant and an organic solvent in a reaction vessel. In some embodiments, the bis (arene) metal cation complex and at least an aqueous reductant and an organic solvent are contacted sequentially, in any order. In some embodiments, the bis (arene) metal cation complex and at least an aqueous reductant and an organic solvent are contacted substantially simultaneously or simultaneously. In some embodiments, the contacting proceeds under biphasic conditions. In some embodiments, the contacting proceeds such that at least one of the bis (arene) metal cation complex, the bis (arene) metal complex, or any combination thereof, is extracted into an organic phase (e.g., organic solvent), with any impurities remaining in the aqueous phase (e.g., dissolved in the aqueous phase, etc.). In some embodiments, the method further comprises separating the aqueous phase from the organic phase, drying the organic phase with a drying agent (e.g., at least one of magnesium sulfate, calcium chloride, potassium hydroxide, sodium hydroxide, or any combination thereof), removing the drying agent by filtration, and removing any residual solvent under reduced pressure to obtain the purified bis (arene) metal complex.

In some embodiments, the bis (arene) metal cation complex is contacted with at least an aqueous reductant and an organic solvent at a temperature of 15° C. to 35° C., or any range or subrange between. For example, in some embodiments, the temperature is a temperature in a range from 20° C. to 35° C., 25° C. to 35° C., 30° C. to 35° C., 15° C. to 30° C., 15° C. to 25° C., or 15° C. to 20° C.

In some embodiments, an aqueous reductant comprises at least one of a sodium hydroxide, a potassium hydroxide, an amine compound, or any combination thereof. In some embodiments, the aqueous reductant has reduction properties. In some embodiments, the aqueous reductant comprises a substance that converts the charged metal of the bis (arene) metal cation complex to a neutral charge.

In some embodiments, the organic solvent comprises an arene compound. In some embodiments, the organic solvent comprises a compound of the formula:

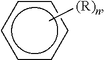

where:

R is independently an alkyl; and

n is 1 to 6.

In some embodiments, the method does not comprise a step of removing at least one impurity by distillation. In some embodiments, the method does not comprise a step of removing at least one impurity by sublimation.

At step 112, in some embodiments, the method comprises separating the bis (arene) metal complex from the organic solvent to obtain a purified bis (arene) metal complex.

In some embodiments, the separating comprises separating the organic solvent or organic phase from the aqueous phase. In some embodiments, the separating comprises drying the organic solvent. In some embodiments, the separating comprises contacting the organic solvent with a drying agent. Non-limiting examples of a drying agent include, for example and without limitation, at least one of a magnesium sulfate, a calcium chloride, a potassium hydroxide, a sodium hydroxide, or any combination thereof. In some embodiments, the separating comprises filtering the drying agent to separate the drying agent from the bis (arene) metal complex. In some embodiments, the separating comprises removing the organic solvent under reduced pressure. For example, in some embodiments, the separating comprises removing the organic solvent from the bis (arene) metal complex under pressure, wherein the pressure is less than an ambient pressure.

In some embodiments, the bis (arene) metal complex is obtained at a purity of at least 95%. For example, in some embodiments, the bis (arene) metal complex is obtained a purity of 95% to 99.9999%, 95% to 99.999%, 95% to 99.99%, 95% to 99.9%, 95% to 99%, 95% to 98%, 95% to 97% 95% to 96%, 96% to 99.9999%, 97% to 99.9999%, 98% to 99.9999%, 99% to 99.9999%, 99.9% to 99.9999%, 99.99% to 99.9999%, 99.999% to 99.9999%, or any range or subrange between 95% and 99.9999%.

In some embodiments, the bis (arene) metal complex comprises less than 5% by weight of at least one impurity based on a total weight of the composition. In some embodiments, the at least one impurity comprises any one or more of the impurities disclosed herein. For example, in some embodiments, the at least one impurity comprises at least one of a bis (arene) metal complex impurity, a hydrocarbon solvent-soluble impurity, an aromatic solvent-soluble impurity, an ethereal solvent-soluble impurity, or any combination thereof.

It will be appreciated that any combination of the steps 102 to 112 can be employed, in any order, without departing from the scope of this disclosure. It will be further appreciated that, when other combinations of the steps 102 to 112 and the order of steps are employed relative to the steps in FIG. 1, the modifiers “first,” “second,” “third,” and so on, are adjusted accordingly.

For example, in some embodiments, methods for purifying bis (arene) metal complexes are provided. The method may generally comprise application of an oxidation reduction sequence, such as, for example and without limitation, the following method. In some embodiments, the method comprises obtaining a first solution comprising a bis (arene) metal complex and at least one first impurity. In some embodiments, the method comprises contacting the first solution with a halide compound to obtain a second solution comprising a bis (arene) metal cation complex and at least one second impurity. In some embodiments, the method comprises separating the bis (arene) metal cation complex from at least a portion of the at least one second impurity. In some embodiments, the method comprises contacting the bis (arene) metal cation complex with an aqueous reductant and an organic solvent to obtain the bis (arene) metal complex in the organic solvent. In some embodiments, the method comprises separating the bis (arene) metal complex from the organic solvent to obtain a purified bis (arene) metal complex.

In some embodiments, methods for increasing conversion of crude reaction mixtures are provided. In some embodiments, the method comprises obtaining a first solution. In some embodiments, the first solution comprises reaction products formed by reacting a first metal halide compound, with a second metal halide compound and a first arene compound to form a bis (arene) metal complex and at least one first impurity. In some embodiments, the at least one first impurity comprises a bis (arene) metal complex impurity. In some embodiments, the method comprises heating the first solution, in a presence of a second arene compound, sufficient to convert a portion of the at least one first impurity to the bis (arene) metal complex.

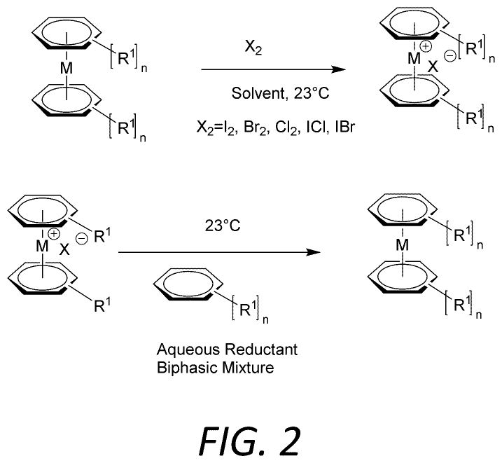

FIG. 2 is a schematic diagram of a reaction scheme for purification via an oxidation-reduction sequence, according to some embodiments. As shown in FIG. 2, the oxidation-reduction sequence for purification involves synthetic conversion of bis (arene) molybdenum-which is hydrocarbon solvent-soluble, aromatic solvent-soluble, and ethereal solvent-soluble-to insoluble bis (arene) molybdenum (I) halide complexes. This allows hydrocarbon solvent-soluble impurities, aromatic solvent-soluble impurities, and ethereal solvent-soluble impurities to be separated by filtration. The oxidation of bis (arene) molybdenum complexes to [bis (arene) molybdenum (I)] [halide] complexes and the reverse reduction of [bis (arene) molybdenum (I)] [halide] to bis (arene) molybdenum complexes is employed as an oxidation-reduction sequence for purification of bis (arene) metal complexes.

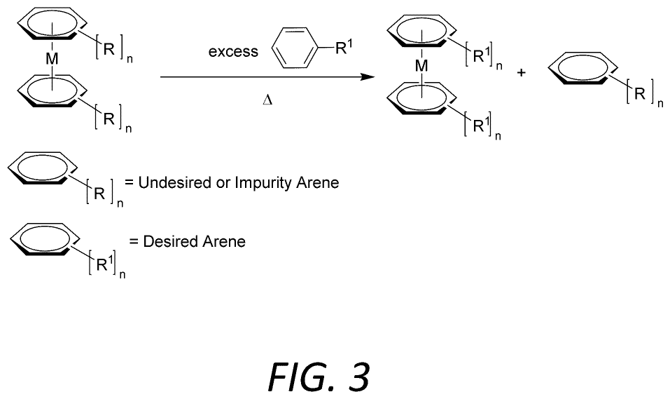

FIG. 3 is a schematic diagram of a reaction scheme for thermal arene metathesis reactions, according to some embodiments. As shown in FIG. 3, thermal arene metathesis reactions are reactions in which higher volatility arenes place lower volatility arenes. In the presence of an excess of the desired arene, the thermal treatment of an impure bis (arene) molybdenum complex mixture, where some of the mixture components comprise bis (arene) molybdenum complexes with higher molecular weight, lower volatility arenes (impurity arenes) coordinated to a molybdenum center, results in the displacement of the impurity arenes by the excess desired arene.

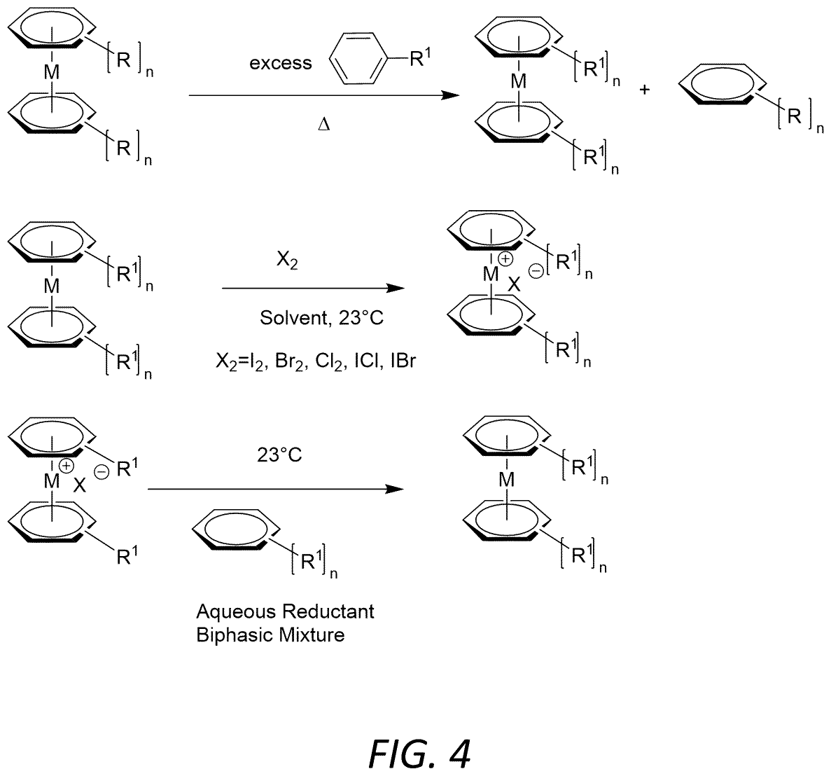

FIG. 4 is a schematic diagram of a reaction scheme for a combination of thermal arene metathesis and oxidation-reduction sequence, according to some embodiments. As shown in FIG. 4, when a thermal step to displace impurity arenes (FIG. 3) is combined with an oxidation-reduction sequence (FIG. 2), a higher purity pure bis (arene) molybdenum complex is achieved than would otherwise be generated by the purification of the bis (arene) metal complex by conventional methods, such as, for example and without limitation, sublimation and/or distillation (either at atmospheric or reduced pressure conditions) because the purification by sublimation and/or distillation requires elevated temperatures at which the lower volatility arene impurities that are present undergo arene metathesis reactions to displace the desired arene. The methods in FIG. 4 also remove other involatile impurities (inorganic and organic) either by virtue of their solubility in the solvent or by the treatment with the aqueous reductant that removes water soluble or water reactive impurities.

In some embodiments, a method comprises one or more of the following steps: heating the impure bis (arene) molybdenum complex (e.g., 80° C. to 160° C.) in the presence of an excess (e.g., 10 to 50 equivalents) of the desired arene; filtering the solution to remove insoluble precipitate; contacting the thermolyzed solution of the bis (arene) molybdenum with at least 1 equivalent of a halide compound (e.g., I₂, Br₂, Cl₂, ICl, IBr); concentrating the solution by removing excess solvent under reduced pressure; filtering the solution to collect the desired [bis (arene) Molybdenum (I)] [halide] complex; contacting the [bis (arene) Molybdenum (I)] [halide] complex with a solution of an aqueous reductant (e.g., NaOH, KOH, etc.) under biphasic conditions with the desired arene as the organic phase; separating the organic and aqueous phases; drying the organic phase with a drying agent (e.g., magnesium sulfate, calcium chloride, KOH, NaOH, etc.); and filtering the drying agent; and removing the solvent under reduced pressure to obtain a purified bis (arene) metal complex product.

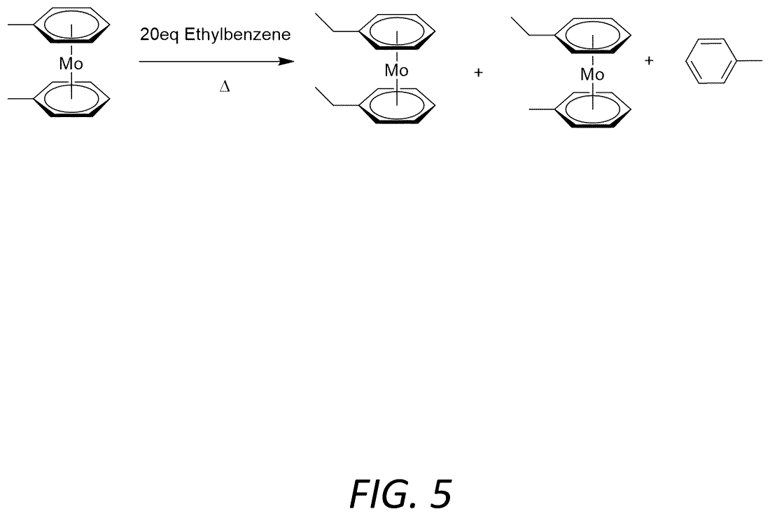

FIG. 5 is a schematic diagram of a reaction scheme for increased conversion of crude product, according to some embodiments. As shown in FIG. 5, the conversion of (Ar)₂Mo to (Ar¹)₂Mo (arene metathesis reaction) is a synthetic method that is useful in generating a pure bis (arene) molybdenum complex. This can be used to purify a mixture of bis (arene) molybdenum complexes or it can be used to change from one arene ligand to another arene ligand. In many cases, the synthesis of bis (arene) molybdenum complexes is plagued by the formation of polyalkylated arene complexes; in general, the Fischer Hafner Synthesis (FHS) with any arene bearing a two carbon or higher substituent results in the formation of a mixture of polyalkylated arene complexes. This reaction is documented in the scientific literature which used the bis (benzene) molybdenum as the starting material and used a temperature of 160° C. in a sealed tube reaction. A method that does not require such a high temperature and pressurized conditions is attractive for a few reasons. (1) A lower temperature results in less thermal decomposition of the bis (arene) molybdenum complex. (2) The equilibrium of the reaction can be shifted by removing the displaced arene, this is most easily accomplished by using atmospheric or sub-atmospheric pressures in the process. (3) Lowering the temperature negates the need for a pressure reaction. Since pressure reactions require more highly engineered apparatus to safely carry out the process at scale, a lower temperature for the reaction allows more scaleable conditions. The following examples show that there is a catalyst present in the impure material that can lower the temperature required for the arene metathesis reaction. The conversion of impure (˜75% purity) bis (toluene) molybdenum to bis (ethylbenzene) molybdenum was monitored at 145° C. over time at ambient pressure. In a second experiment, the conversion of impure bis (toluene) molybdenum was monitored by ¹H NMR at different temperatures by heating for 24 hour periods and in a sublimed bis (toluene) molybdenum of much higher purity. This experiment showed that the conversion could take place as low as temperatures of 80° C. and that the rate at 100° C. was much lower in purified bis (toluene) molybdenum than unpurified bis (toluene) molybdenum.

### EXAMPLE 1

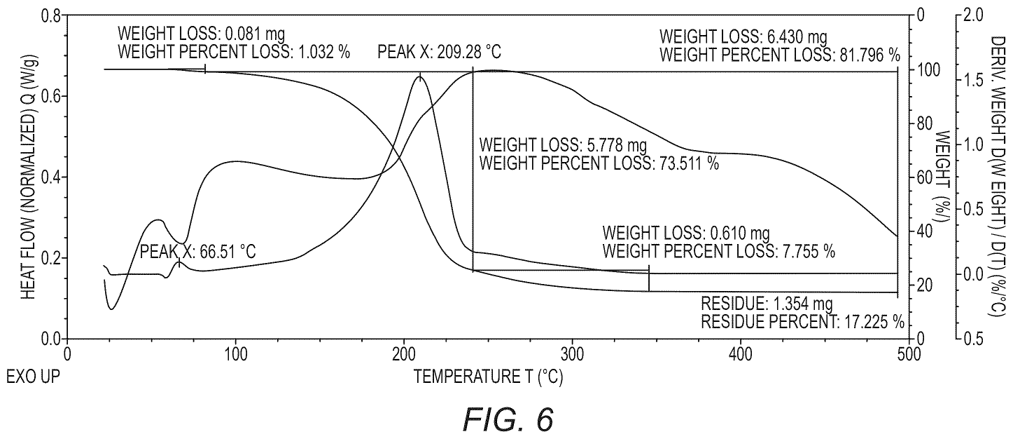

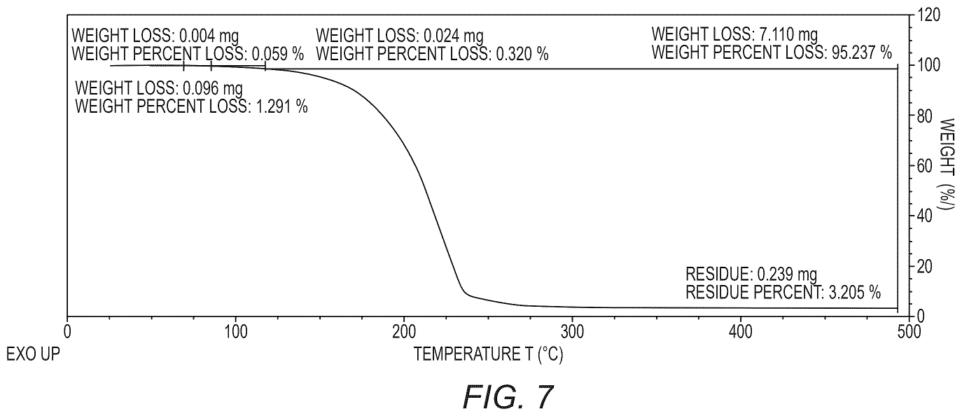

A 100 mL flask was charged with 5.00 g of crude bis (toluene) molybdenum with 75% purity by thermogravimetric analysis (TGA) (13.4 mmol) and 33 g of toluene (20 eq). The solution was heated in an oil bath at 116° C. for 48 h, filtered through a medium porosity frit to remove some dark precipitate, then treated with 1.70 g iodine (1.0 eq based on 75% purity). The yellow-green [(toluene)₂Mo][I] precipitate that formed was filtered away and dried under vacuum to give 4.90 g [(toluene)₂Mo][I] (12.0 mmol, 90% yield). The recovered iodide salt was suspended in 50 mL toluene and treated with 30 mL of a 30 wt % solution of potassium hydroxide with vigorous stirring. This was continued for 24 h. The yellow aqueous solution was then discarded and the green toluene product solution was dried over magnesium sulfate, filtered, and washed with 2×10 mL aliquots of toluene. The combined filtrates were stripped of solvent to give 2.50 g of green solid which was 97% pure as determined by TGA. FIG. 6 is a graphical view of the thermogravimetric analysis (TGA) for the impure cured bis (toluene) molybdenum, according to some embodiments. FIG. 7 is a graphical view of the thermogravimetric analysis for the purified bis (toluene) molybdenum, according to some embodiments.

### EXAMPLE 2

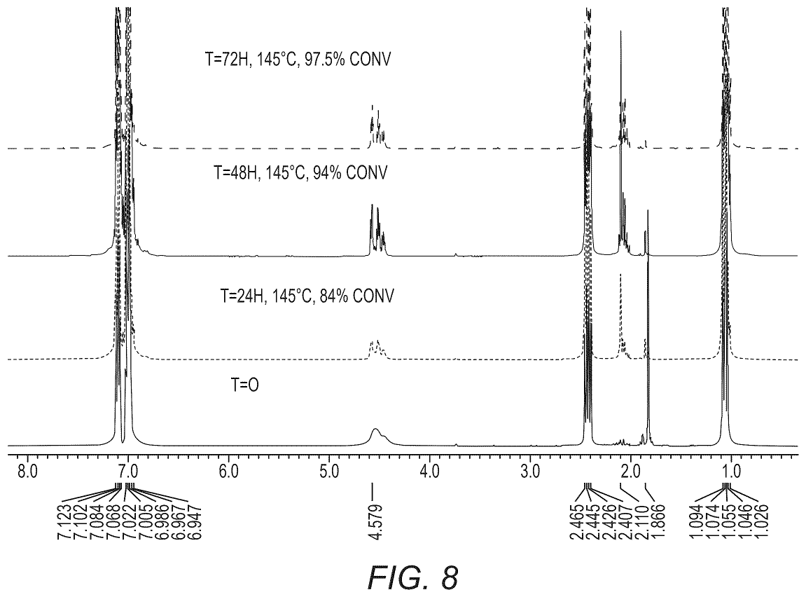

To show conversion over time at 145° C. as monitored by ¹H NMR, a solution of 5 g (17.8 mmol) of impure bis (toluene) molybdenum (˜75% purity) in ethylbenzene (38 g, 20 eq) in a 100 mL round bottom flask was heated in an oil bath at 145° C. and atmospheric pressure under nitrogen. Heating was continued for 26 h; then the reaction mixture was allowed to cool. The reaction mixture was then analyzed by ¹H NMR and the percent conversion calculated by summing the integrals for the methyl and methine groups of the coordinated toluene and ethylbenzene, respectively, then normalizing by the appropriate number of protons. The overlap of the free toluene with the coordinated ethylbenzene resonances was neglected. Heating was continued in 24 hour increments up to 72 hours, resulting in 97.5% conversion as determined by ¹H NMR. FIG. 8 is a graphical view of ¹H NMR spectrum showing the conversion over time (0 to 72 h, at 145° C.) for ethylbenzene arene metathesis reactions, according to some embodiments.

### EXAMPLE 3

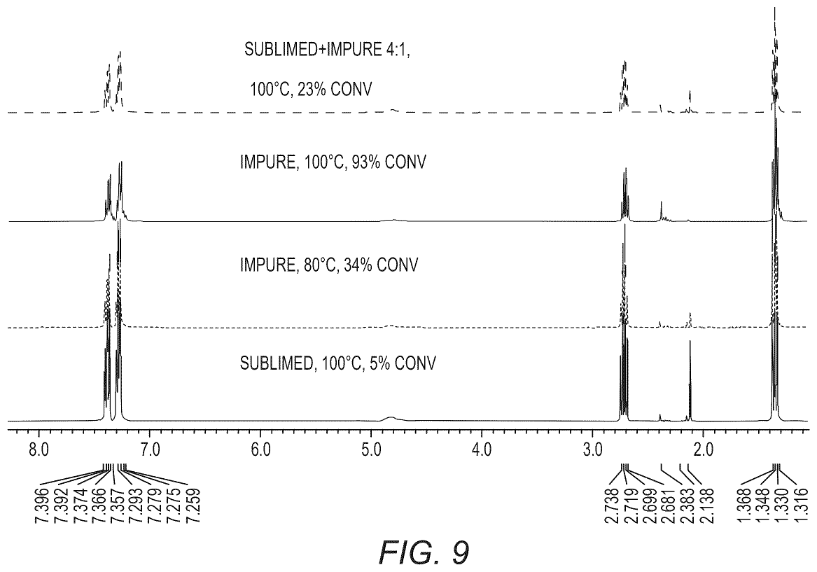

To show conversion at different temperatures over 24 hours, as monitored by ¹H NMR, a solution of 5 g (17.8 mmol) of impure bis (toluene) molybdenum (˜75% purity) in ethylbenzene (38 g, 20 eq) in a 100 mL round bottom flask was heated to the internal temperatures indicated in Table 1 for a period of 24 hours under nitrogen. The reaction mixture was then analyzed by ¹H NMR and the percent conversion calculated by summing the integrals for the methyl and methine groups of the coordinated toluene and ethylbenzene, respectively, then normalizing by the appropriate number of protons. The overlap of the free toluene with the coordinated ethylbenzene resonances was neglected. FIG. 9 is a graphical view of ¹H NMR spectrum showing conversion over time (0 to 24 h, at various temperatures), according to some embodiments.

TABLE 1

| Bis(toluene) Molybdenum Source | Conditions | % Conversion |
|---|---|---|
| Impure (~75%) | 100° C., 24 h | 93 |
| Impure (~75%) | 80° C., 24 h | 34 |
| Sublimed (94%) | 100° C., 24 h | 5 |
| Sublimed + Impure 4:1 | 100° C., 24 h | 23 |

### EXAMPLE 4

Synthesis of Impure Bis (toluene) Molybdenum Used in Arene Metathesis and Purification Experiments. A 4 L reaction flask was charged with MoCl₄ (250.43 g, 1.053 mol, 1.00 eq), aluminum chloride (252.75 g, 1.80 mol, 1.80 eq), aluminum powder (32.51 g, 1.205 mol, 1.14 eq) and toluene (1910 g). The reaction mixture was stirred for 1 hour at ambient temperature and heated to reflux using a heating mantle for 48 hours.

The reaction mixture was allowed to cool, then chilled in an ice bath, charged with magnesium powder (140.67 g, 5.788 mol, 5.50 eq) and tetrahydrofuran (1243 g) in a dropwise fashion. The reaction was heated to reflux for 18 hours. It was then allowed to cool, then filtered and washed with two 1 L aliquots of toluene. The solvent was then distilled away from the filtrates under reduced pressure to near dryness. The resulting brown-green solid was then dissolved in 1084 g of anhydrous toluene and cooled to about 4° C. in an ice bath. The cooled solution in toluene was treated with 84 g of deoxygenated deionized water via slow addition with vigorous stirring. A gelatinous precipitate along with a large exotherm was observed after the addition of about a third of the water. The gelatinous precipitate eventually became more granular and mobile after which time the remainder of the water was added. The reaction mixture was allowed to settle and was then filtered through a coarse porosity frit to give a green filtrate. The filtrates were then stripped of toluene under reduced pressure to give 141 g of a sticky green solid that was analyzed for purity by ¹H NMR (quantitation versus hexamethyldisiloxane internal standard) and by TGA which indicated 70% and 75% purity, respectively.

### EXAMPLE 5

Synthesis of Impure Bis (Ethylbenzene) Molybdenum. A 500 mL 3-neck round bottom flask is charged with molybdenum tetrachloride (10 g, 42.0 mmol, 1.0 eq), aluminum trichloride (9.99 g, 75.0 mmol, 1.79 eq), aluminum powder (1.30 g, 48.3 mmol, 1.15 eq), and ethylbenzene (134 g, 1260 mmol, 30.0 eq). The reaction mixture is stirred and heated to reflux for 24 hours. The reaction mixture is allowed to cool, then chilled in an ice bath, charged with magnesium powder (5.61 g, 231 mol, 5.50 eq) and about 100 mL anhydrous tetrahydrofuran in a dropwise fashion keeping the internal temperature below 20° C. The reaction is heated to reflux for 18 hours then allowed to cool to ambient temperature. The solvent is then distilled away under reduced pressure until the mixture has reached near dryness. The crude product is then extracted with 400 ml of ethylbenzene and filtered to a 1 L flask through a medium porosity frit. The residual salts are washed with 4×100 mL aliquots of ethylbenzene and successively filtered to give about 800 mL of a green product solution. The green product solution is cooled in an ice bath, vigorously stirred, and treated with 15 mL of degassed deionized water in a dropwise fashion over 1 h. The toluene product solution is filtered away from the precipitate that forms after the water addition, and the filtrates are stripped of solvent under reduced pressure to give a green oil as the product.

### ASPECTS

Various Aspects are described below. It is to be understood that any one or more of the features recited in the following Aspect(s) can be combined with any one or more other Aspect(s).

Aspect 1. A method comprising:
obtaining a first solution comprising a bis (arene) metal complex and at least one first impurity;
contacting the first solution with a halide compound to obtain a second solution comprising a bis (arene) metal cation complex and at least one second impurity; separating the bis (arene) metal cation complex from at least a portion of the at least one second impurity;
contacting the bis (arene) metal cation complex with an aqueous reductant and an organic solvent to obtain the bis (arene) metal complex in the organic solvent;
separating the bis (arene) metal complex from the organic solvent to obtain a purified bis (arene) metal complex.

Aspect 2. The method according to Aspect 1, wherein the bis (arene) metal complex comprises a compound of the formula:

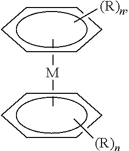

where:
   M is a Cr, Mo, W, Fe, or V;
   R is independently an alkyl; and
   n is 1 to 6.

Aspect 3. The method according to any one of Aspects 1-2, wherein the at least one first impurity is different from the bis (arene) metal complex.

Aspect 4. The method according to Aspect 3, wherein the at least one first impurity comprises at least one compound of the formula:

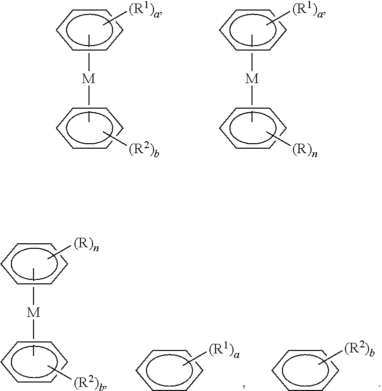

or any combination thereof, where:
   M is a Cr, Mo, W, Fe, or V;
   R is independently an alkyl, an alkenyl, an aryl, or a cycloalkyl;
   R¹ is independently a halogen, a dialkylamino, an alkyl, an alkoxy, an aryl, aralkyl, or a cycloalkyl;
   R² is independently a halogen, a dialkylamino, an alkyl, an alkoxy, an aryl, aralkyl, or a cycloalkyl;
   n is 1 to 6;
   a is 1 to 6;
   b is 1 to 6.

Aspect 5. The method according to Aspect 4, wherein (R¹)ₐ and (R²)_{b} are different from (R)ₙ.

Aspect 6. The method according to any one of Aspects 1-5, wherein the halide compound comprises at least one of I₂, Br₂, Cl₂, ICl, IBr, or any combination thereof. Aspect 7. The method according to any one of Aspects 1-6, wherein the bis (arene) metal cation complex comprises a compound of the formula:

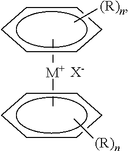

where:
   M is a Cr, Mo, W, Fe, or V;
   X is Cl, Br, I, or F;
   R is independently an alkyl; and
   n is 1 to 6.

Aspect 8. The method according to any one of Aspects 1-7, wherein the at least one second impurity comprises at least one of the at least one first impurity, a hydrocarbon solvent-soluble impurity, an aromatic solvent-soluble impurity, an ethereal solvent-soluble impurity, or any combination thereof.

Aspect 9. The method according to any one of Aspects 1-8, wherein the aqueous reductant comprises at least one of a sodium hydroxide, a potassium hydroxide, an amine compound, or any combination thereof.

Aspect 10. The method according to any one of Aspects 1-9, wherein the organic solvent comprises a compound of the formula:

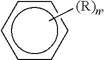

where:
   R is independently an alkyl; and
   n is 1 to 6.

Aspect 11. The method according to any one of Aspects 1-10, wherein a step of contacting the first solution with the halide compound is conducted at a temperature of 15° C. to 35° C.

Aspect 12. The method according to any one of Aspects 1-11, wherein a step of separating the bis (arene) metal cation complex from at least a portion of the at least one second impurity is conducted by filtering.

Aspect 13. The method according to any one of Aspects 1-12, wherein a step of contacting the bis (arene) metal cation complex with the aqueous reductant and the organic solvent is conducted at a temperature of 15° C. to 35° C.

Aspect 14. The method according to any one of Aspects 1-13, wherein a step of separating the bis (arene) metal complex from the organic solvent comprises drying with a drying agent and removing the organic solvent.

Aspect 15. The method according to any one of Aspects 1-14, wherein the purified bis (arene) metal complex is obtained at a purity of at least 95%.

Aspect 16. A method comprising:
obtaining a first solution,
   wherein the first solution comprises reaction products formed by reacting a first metal halide compound, with a second metal halide compound and a first arene compound to form a bis (arene) metal complex and at least one first impurity;
   wherein the at least one first impurity comprises a bis (arene) metal complex impurity;
heating the first solution, in a presence of a second arene compound, sufficient to convert a portion of the at least one first impurity to the bis (arene) metal complex.

Aspect 17. The method according to Aspect 16, wherein the heating is conducted for a duration sufficient to convert at least 95% of the at least one first impurity to the bis (arene) metal complex.

Aspect 18. The method according to any one of Aspects 16-17, wherein the heating is conducted at a temperature of 30° C. to 160° C.

Aspect 19. A composition comprising:
a bis (arene) metal complex of the formula:

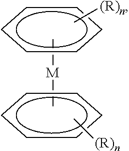

where:
   M is a Cr, Mo, W, Fe, or V;
   R is independently an alkyl; and
   n is 1 to 6;
wherein the bis (arene) metal complex is present in the composition at a purity of at least 95%.

Aspect 20. The composition according to Aspect 19, wherein the composition comprises:
less than 5% by weight of at least one impurity based on a total weight of the composition,
   wherein the at least one impurity comprises at least one of a bis (arene) metal complex impurity, a hydrocarbon solvent-soluble impurity, an aromatic solvent-soluble impurity, an ethereal solvent-soluble impurity, or any combination thereof.

What is claimed is:

1. A method comprising:
obtaining a first solution comprising a bis (arene) metal complex and at least one first impurity;
contacting the first solution with a halide compound to obtain a second solution comprising a bis (arene) metal cation complex and at least one second impurity;
separating the bis (arene) metal cation complex from at least a portion of the at least one second impurity;
contacting the bis (arene) metal cation complex with an aqueous reductant and an organic solvent to obtain the bis (arene) metal complex in the organic solvent; and
separating the bis (arene) metal complex from the organic solvent to obtain a purified bis (arene) metal complex.

2. The method of claim 1, wherein the bis (arene) metal complex comprises a compound of the formula: 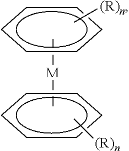
where:
M is a Cr, Mo, W, Fe, or V;
R is independently an alkyl; and
n is 1 to 6.

3. The method of claim 1, wherein the at least one first impurity is different from the bis (arene) metal complex.

4. The method of claim 3, wherein the at least one first impurity comprises at least one compound of the formula: 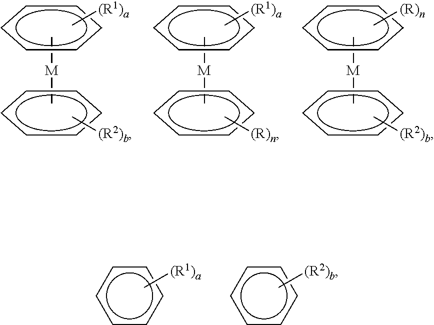
or any combination thereof, where:
M is a Cr, Mo, W, Fe, or V;
R is independently an alkyl, an alkenyl, an aryl, or a cycloalkyl;
R¹ is independently a halogen, a dialkylamino, an alkyl, an alkoxy, an aryl, aralkyl, or a cycloalkyl;
R² is independently a halogen, a dialkylamino, an alkyl, an alkoxy, an aryl, aralkyl, or a cycloalkyl;
n is 1 to 6;
a is 1 to 6;
b is 1 to 6.

5. The method of claim 4, wherein (R¹)ₐ and (R²)_{b} are different from (R)ₙ.

6. The method of claim 1, wherein the halide compound comprises at least one of I₂, Br₂, Cl₂, ICl, IBr, or any combination thereof.

7. The method of claim 1, wherein the bis (arene) metal cation complex comprises a compound of the formula: 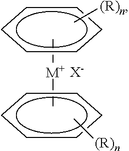
where:
M is a Cr, Mo, W, Fe, or V;
X is Cl, Br, I, or F;
R is independently an alkyl; and
n is 1 to 6.

8. The method of claim 1, wherein the at least one second impurity comprises at least one of the at least one first impurity, a hydrocarbon solvent-soluble impurity, an aromatic solvent-soluble impurity, an ethereal solvent-soluble impurity, or any combination thereof.

9. The method of claim 1, wherein the aqueous reductant comprises at least one of a sodium hydroxide, a potassium hydroxide, an amine compound, or any combination thereof.

10. The method of claim 1, wherein the organic solvent comprises a compound of the formula: 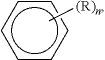
where:
R is independently an alkyl; and
n is 1 to 6.

11. The method of claim 1, wherein a step of contacting the first solution with the halide compound is conducted at a temperature of 15° C. to 35° C.

12. The method of claim 1, wherein a step of separating the bis (arene) metal cation complex from at least a portion of the at least one second impurity is conducted by filtering.

13. The method of claim 1, wherein a step of contacting the bis (arene) metal cation complex with the aqueous reductant and the organic solvent is conducted at a temperature of 15° C. to 35° C.

14. The method of claim 1, wherein a step of separating the bis (arene) metal complex from the organic solvent comprises drying with a drying agent and removing the organic solvent.

15. The method of claim 1, wherein the purified bis (arene) metal complex is obtained at a purity of at least 95%.

16. A method comprising:
obtaining a first solution,
wherein the first solution comprises reaction products formed by reacting a first metal halide compound, with a second metal halide compound and a first arene compound to form a bis (arene) metal complex and at least one first impurity;
wherein the at least one first impurity comprises a bis (arene) metal complex impurity; and
heating the first solution, in a presence of a second arene compound, sufficient to convert a portion of the at least one first impurity to the bis (arene) metal complex.

17. The method of claim 16, wherein the heating is conducted for a duration sufficient to convert at least 95% of the at least one first impurity to the bis (arene) metal complex.

18. The method of claim 16, wherein the heating is conducted at a temperature of 30° C. to 160° C.

19. A composition comprising:
a bis (arene) metal complex of the formula: 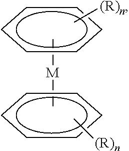
where:
M is a Cr, Mo, W, Fe, or V;
R is independently an alkyl; and
n is 1 to 6;
wherein the bis (arene) metal complex is present in the composition at a purity of at least 95%.

20. The composition of claim 19, wherein the composition comprises:
less than 5% by weight of at least one impurity based on a total weight of the composition,
wherein the at least one impurity comprises at least one of a bis (arene) metal complex impurity, a hydrocarbon solvent-soluble impurity, an aromatic solvent-soluble impurity, an ethereal solvent-soluble impurity, or any combination thereof.
